(19) United States
(12) Patent Application Publication
(10) Pub. No.: US 2008/0171577 A1
(43) Pub. Date: Jul. 17, 2008

(54) EXTERNAL MEMORIES ARCHITECTURE TO ENABLE SOFTWARE PARTITION AND CUSTOMIZATION FOR MOBILE TERMINALS WITH INSERTABLE COMMUNICATIONS CARDS

(75) Inventors: William X. Huang, San Ramon, CA (US); Shanquan Bao, Alameda, CA (US); Liming Gao, Alameda, CA (US); Guang Wan, Fremont, CA (US)

Correspondence Address: UTSTARCOM, INC.;c/o Laura Weiss, Paralegal, 3800 Golf Road, Suite 220, Rolling Meadows, IL, 60008, US

(73) Assignee: UTSTARCOM, INC, Alameda, CA (US)

(21) Appl. No.: 11/623,432

(22) Filed: Jan. 16, 2007

(51) Int. Cl. H04M 1/02

(52) U.S. Cl. 455/558

(57) ABSTRACT

A dual memory architecture for software partition on mobile terminals incorporates a mobile information device (MID) handset having a first memory; a plurality of host peripherals; and a card interface. A miniaturized form factor card (mobile card) incorporating wireless communications components is received in the card interface and includes a second memory including default host peripheral drivers. The interface provides operable connection from the MID memory to the mobile card. In certain embodiments, the first memory includes device specific host peripheral drivers, which are uploaded to the mobile card second memory upon insertion of the mobile card in the card interface.

### REFERENCE TO RELATED APPLICATIONS

This application is co-pending with U.S. application Ser. No. 11/308,221 filed on Mar. 13, 2006 entitled MINIATURIZED FORM FACTOR WIRELESS COMMUNICATIONS CARD FOR GENERIC MOBILE INFORMATION DEVICES and having the same assignee as the present application.

### BACKGROUND OF THE INVENTION

1. Field of the Invention

This invention relates generally to the field of operating platforms for mobile phones and personal data systems and more particularly to an architecture for multiple memories for partitioning of software and functionality in wireless terminals.

2. Related Art

Current design time-to-market for mobile phone and personal information devices is extended due to current design philosophy and practice. Turn-around time for a typical complete handset design is about 9 months. Currently terminal vendors need to spend significant amount of resources on basic wireless communication functions and cannot concentrate on truly value-added design works, such as industrial design and software applications. It is also difficult to develop multiple models with significant differences based on a common printed circuit board (PCB) platform. Traditional wireless devices using discrete solution have difficulty supporting multiple band or modes such as GSM, CDMA, 3G. Discrete chipset solutions consume at least three times more PCB space. There are significant financial and technical barriers of entry for new companies without significant resources, or established companies without wireless expertise.

U.S. patent application Ser. No. 11/308,221 filed on Mar. 13, 2006 entitled MINIATURIZED FORM FACTOR WIRELESS COMMUNICATIONS CARD FOR GENERIC MOBILE INFORMATION DEVICES, which is incorporated herein by reference in its entirety as though fully set forth, provides a system that can save RF tuning, debugging and certification thereby reducing design lead time significantly. This system provides the ability to integrate hardware, software, utilities and drivers which will allow true plug and play functionality for end users or mobile information device design houses. The desired functional capability is provided through an insertable card, referred to herein as a mobile card, to provide a separate CPU or applications processor in the mobile information device for desired functionality and additionally, to provide a complete modem solution that will support multi-mode and multi-band.

For many mobile information devices (MIDs), mobile card structures are not optimized for high to mid end handsets that demand easy software customization. Reliance upon memory solely in the mobile card for functionality on the MID requires that the mobile card structure carry large and expensive memories such as flash and SDRAM. Additionally, without external memory support, handset software developers will be limited to mobile card size and development cycle. With a separated memory structure, MID handset developers can develop software based on local customer requirements independent of mobile card development.

It is therefore desirable to provide a method and apparatus for employing multiple memory capability in a mobile card and MID. In particular, where a mobile card is employed for communications functions wherein a separate processor is employed, it is desirable to provide a separate memory for the MID and a partitioning method to allow interaction between the dual memory structure, the mobile card processor and functions and the MID processor.

### SUMMARY OF THE INVENTION

The present invention provides a dual memory architecture for software partition on mobile terminals which incorporates a mobile information device (MID) handset having a first memory; a plurality of host peripherals; and a card interface. A miniaturized form factor card (mobile card) incorporating wireless communications components is received in the card interface and includes a second memory including default host peripheral drivers. The interface provides operable connection from the MID memory to the mobile card. In certain embodiments, the first memory includes device specific host peripheral drivers, which are uploaded to the mobile card second memory upon insertion of the mobile card in the card interface.

### BRIEF DESCRIPTION OF THE DRAWINGS

These and other features and advantages of the present invention will be better understood by reference to the following detailed description when considered in connection with the accompanying drawings wherein:

FIG. 1 is a depiction of the mobile card and its various applications demonstrating the dual memory architecture of the present invention;

FIG. 2 is a representation of a watch application for an embodiment of the invention herein;

FIG. 3 is a representation of a first multimedia storage device application for an embodiment of the invention herein;

FIG. 4 is a representation of a second multimedia storage device application for an embodiment of the invention herein;

FIG. 5 is a pictorial representation of the development and downloading of device specific software into a Mobile Information Device Memory by a developer;

FIG. 6 is a depiction of the insertion of a mobile card into the MID;

FIG. 7 is a depiction of uploading device specific software from the MID memory into the mobile card;

FIG. 8 is a work flow diagram of the upload process and peripheral settings operation by the mobile card;

FIG. 9 is an exemplary AJAR open software interface employed in exemplary embodiments of the present invention;

FIG. 10 is a block diagram of an exemplary simple handset employing an embodiment of the present invention;

FIG. 11 is a block diagram of an exemplary complex handset employing an embodiment of the present invention; and

FIG. 12 is a work flow diagram depicting the bridging operation of the MID memory for mobile card operation with the MID primary applications processor.

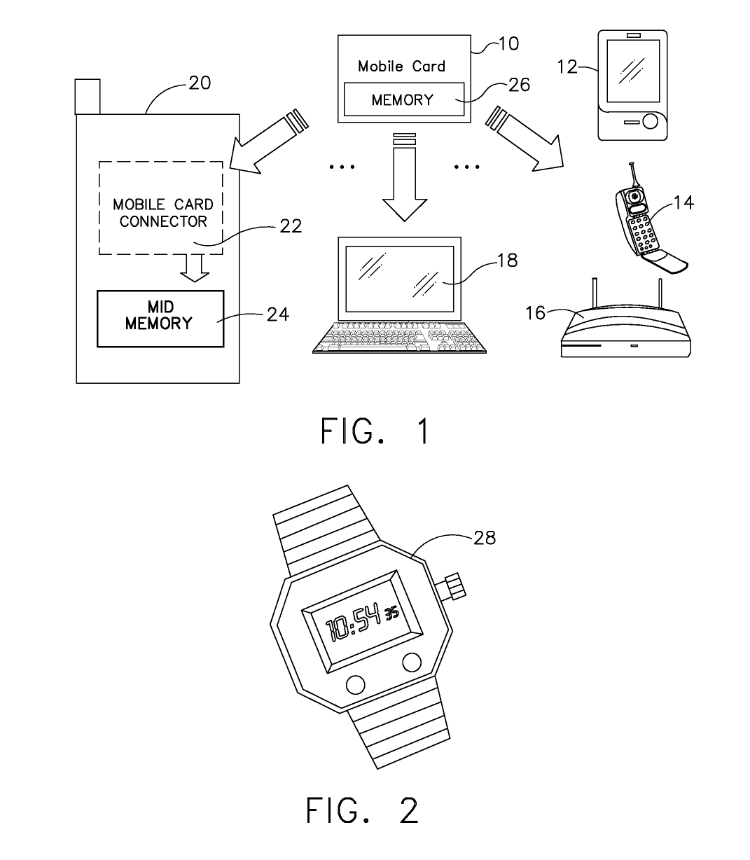

### DETAILED DESCRIPTION OF THE INVENTION

FIG. 1 demonstrates an exemplary embodiment of the present invention. A miniaturized form factor communications card or mobile card 10 as described in prior referenced U.S. application Ser. No. 11/308,221 for wireless communications functionality, is insertable in multiple Mobile Information Devices (MID such as Personal Digital Assistants 12, mobile phone handsets 14 and wireless access points 16. For certain embodiments, the mobile card is employed in personal computers 18 or such devices as vending machines. A generic MID 20 demonstrates a connector interface 22 for the mobile card and includes MID memory 24. For the exemplary MID and mobile card embodiment, mobile card memory 26 carries generic software for basic wireless operations that are identical or irrelevant to local handset consumers, for example, wireless protocol stacks related to wireless technologies. MID memory 24 carries application software or database information customized or tailored for different markets, application and consumers, for example, a Handset Language font database with Chinese font for the China market, Spanish font for Latin America markets or standard English fonts.

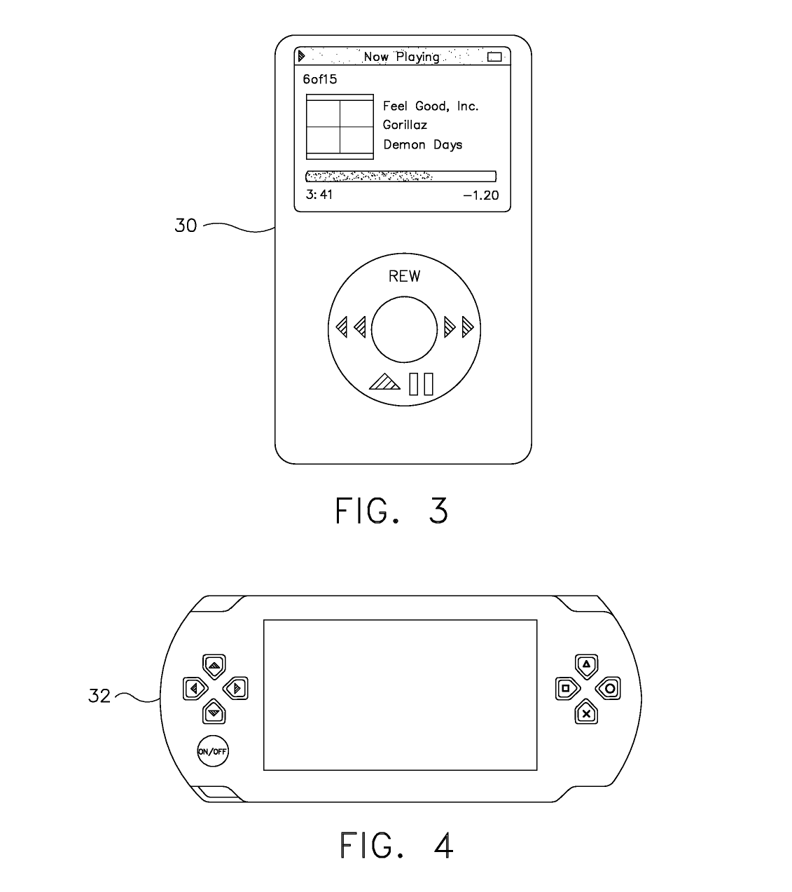

A first specific application for the mobile card in an embodiment employing the present invention is shown in FIG. 3 wherein the mobile card is employed in a sport watch handset 28. A brand developer such as Nike will develop the watch handset related software such as special LCD and keypad driver, and watch type handset user menu that will be downloaded into the watch handset memories which will cooperate with the mobile card, as described subsequently, while mobile card is plugged in.

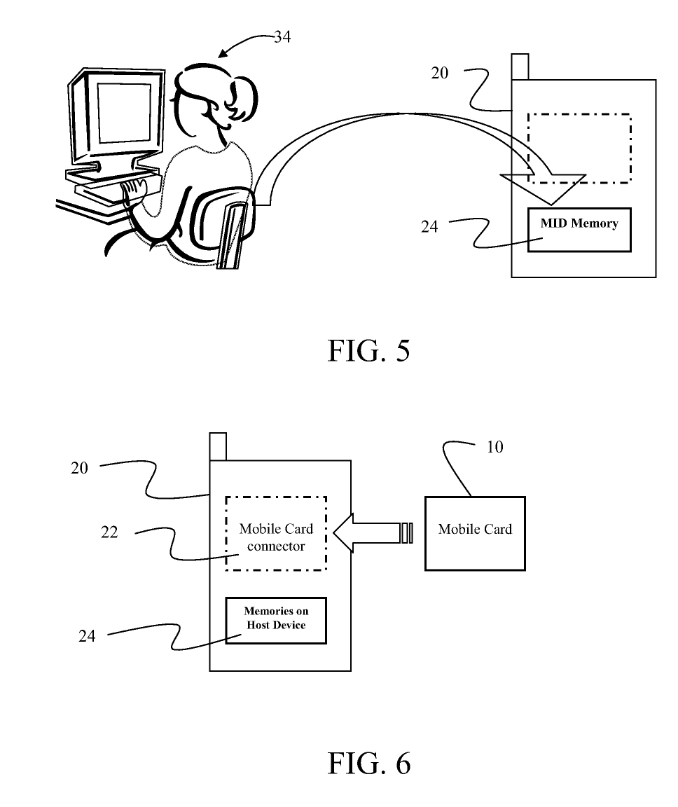

Alternative embodiments are shown in FIGS. 4 and 5 wherein a device manufacturer such as Apple could develop an iPod™ phone 30 by only developing software to be embedded in the iPod™ to enable a mobile card. Similarly, a second developer such as Sony can develop a PSP™ phone 32 with only external memory software development for support of the mobile card. The same mobile card is employed in both devices with each device retaining its proprietary character and operating elements.

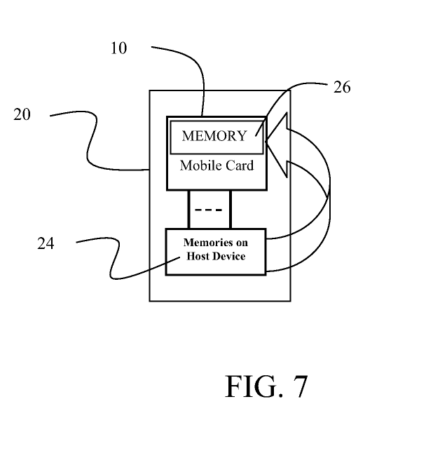

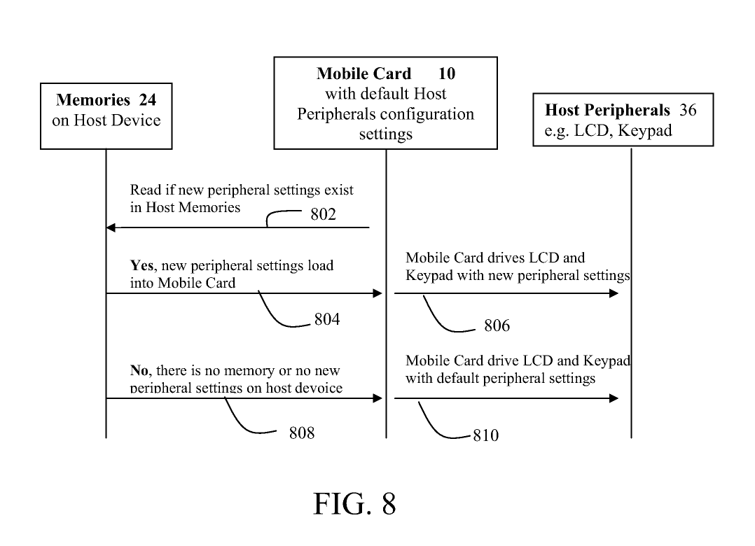

As depicted in FIG. 6, developer 34 codes the interface software for the mobile card as a portion of the software development for an MID 20 and downloads the software into MID memory 24. mobile card 10 is inserted into the receiving connector 22 as shown in FIG. 7 either by the developer or the end user as an added accessory. FIG. 8 shows the uploading of data from the MID memory into the inserted Mobile card for device specific operation.

As shown in FIG. 8, mobile card 10 carries default Host Peripherals configuration settings. Upon insertion in the MID the mobile card queries memories 24 on the host device 802 to determine if the Host Memories provide new peripheral settings for the Host peripherals 36 such as the LCD 36a and keypad 36b which are specific to the MID in which the mobile card has been inserted. If new peripheral settins are provided 804, the mobile card drives the MID LCD and Keypad with uploaded new peripheral settings 806 specific to the MID. If in response to the query there are no MID specific settings 808, the mobile card drives MID peripherals with the default peripherals settings 810.

To support uploading of data from the MID memory to the mobile card, an open and compatible hardware and software interface is employed. In the exemplary embodiments disclosed herein, a standard 8 bit NAND flash bus is employed as a hardware interface. An exemplary bus definition is provided in Table 1.

TABLE 1

| Pin | |
|---|---|
| Name | Function |
| I/O[7:0] | I/O pins used to send commands, address, and data to the |
| | device, and receive data during read operations. |
| CLE | Command Latch Enable. The CLE input controls writing to the |
| | command register. When CLE is high, the command is loaded |
| | on the rising edge of WE#. |
| ALE | Address Latch Enable. The ALE input controls writing to the |
| | address register. When ALE is high, the address is loaded on the |
| | rising edge of WE#. ALE must remain high during the entire |
| | address sequence. |
| CE# | Chip Enable. The CE# input controls the active vs. standby |
| | mode of the device. During a command or address load |
| | sequence, CE# must be low prior to the falling edge of WE#. |
| RE# | Read Enable. The RE# input controls the data and status output |
| | on the I/O lines. The data output is triggered on the falling edge |
| | of RE#. |
| WE# | Write Enable. The WE# input controls the data and command on |
| | the I/O lines during a write sequence. The I/O lines are latched |
| | on the rising edge of the WE# signal. |
| WP# | Write Protect. The WP# input provides protection when |
| | programming or erasing the device. The internal voltage |
| | regulator is reset when WP# is low, preventing any program or |
| | erase operations |
| SE# | Spare Area Enable. The SE# input controls access to the 16 |
| | bytes of spare area on each page. When SE# is not asserted |
| | (high), the spare area for the selected page is not enabled. When |
| | SE# is asserted (low), access to the spare area is enabled. |
| RY/ | Ready/Busy Output. The RY/BY# output indicates the operation |
| BY# | status of the device. When RY/BY# is high, the device is ready |
| | for the next operation. When RY/BY# is low, an internal |
| | program, erase, or random read operation is in progress. |

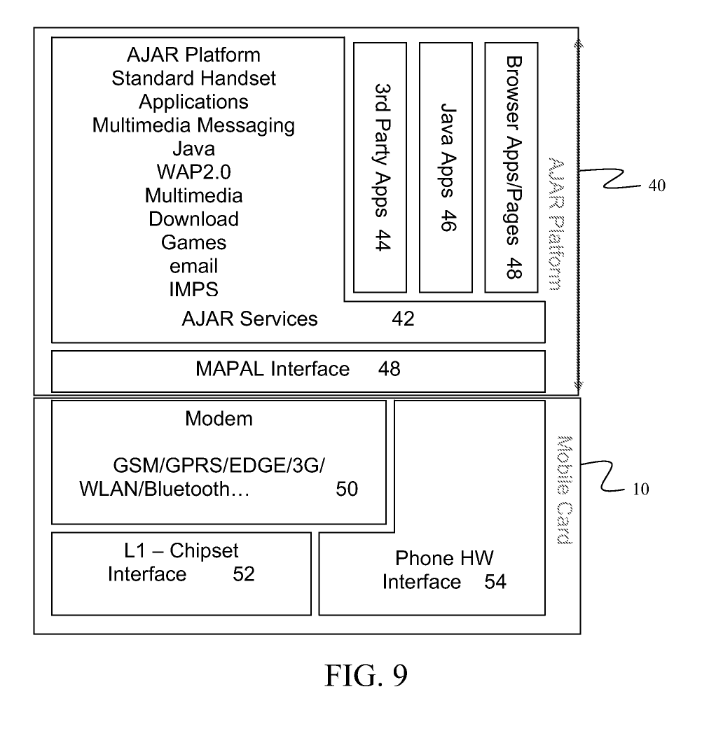

An exemplary software interface for the mobile card and MID is a standard Application Programming Interface (API), such as AJAR™ from TTPCOM, which provides a standard application interface platform. This standard API allows the handset developer to develop application software or port third party programs freely and independently from the mobile card internal operating system. As shown in FIG. 9, AJAR platform 40 incorporated in the MID provides services 42 for standard applications on the handset such as multimedia messaging, Java™, Wireless Application Protocol (WAP) 2.0, Multimedia download, games, e-mail and IMPS. Third party applications 44, Java™ applications 46 and Browser applications/pages 48 are integrated in the AJAR Platform. A MAPAL interface 48 provides exemplary interfacing capability to the mobile card which includes functions for Modem 50 with Global System for Mobile Communications (GSM) devices, General Packet Radio Service (GPRS), Enahnced Data Rates for Global Evolution (EDGE), Third Generation (3G), Wireless local area network (WLAN) or Bluetooth™ communications protocols, an L1 chipset interface 52 and a phone hardware interface 54.

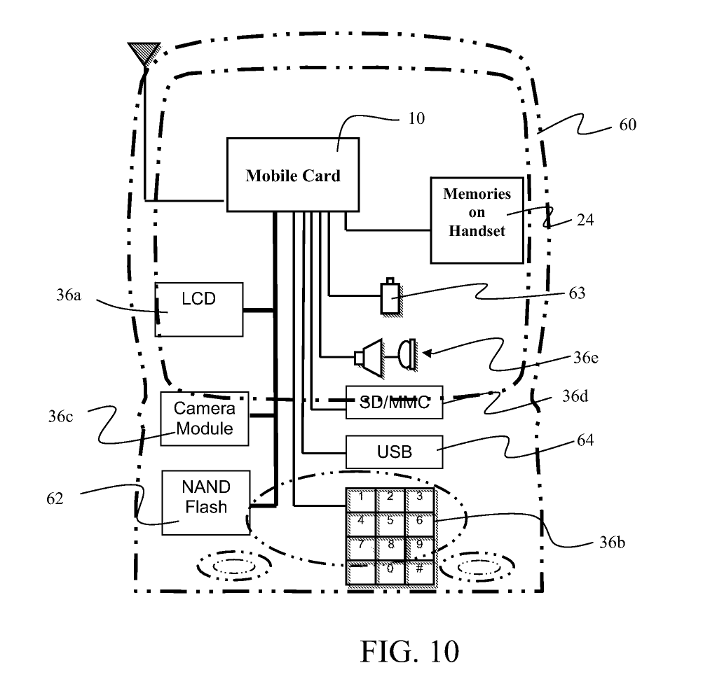

As previously described, the mobile card obtains all the customized software components and operates to provide complete handset functions. In a low or mid end phone 60, as shown in FIG. 10, the mobile card employs a NAND Flash interface 62 to upload software from handset memories 24 and to drive customized peripherals such as LCD 36a, keypad 36b, Camera module 36c, SD/MMC 36d and speaker and microphone set 36e. A battery 63 provides power for the MID and the inserted mobile card. A Universal Serial Bus (USB) interface 64 for the mobile card is also shown for this embodiment.

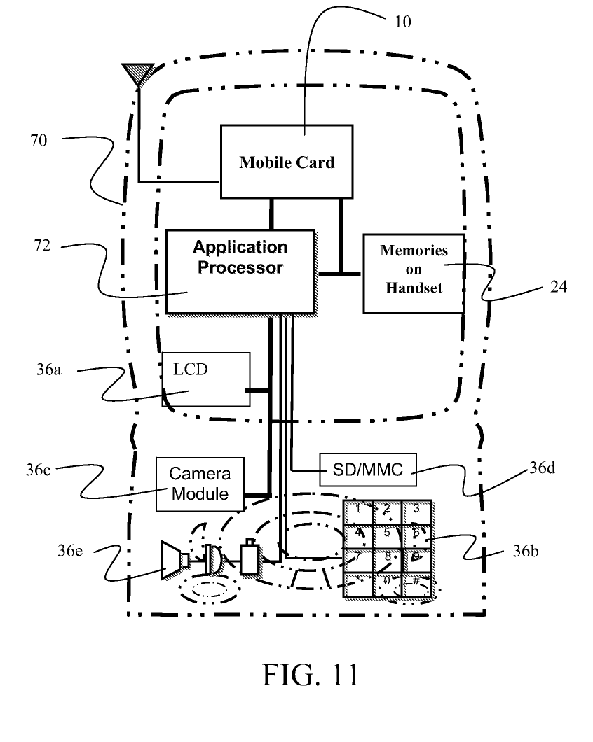

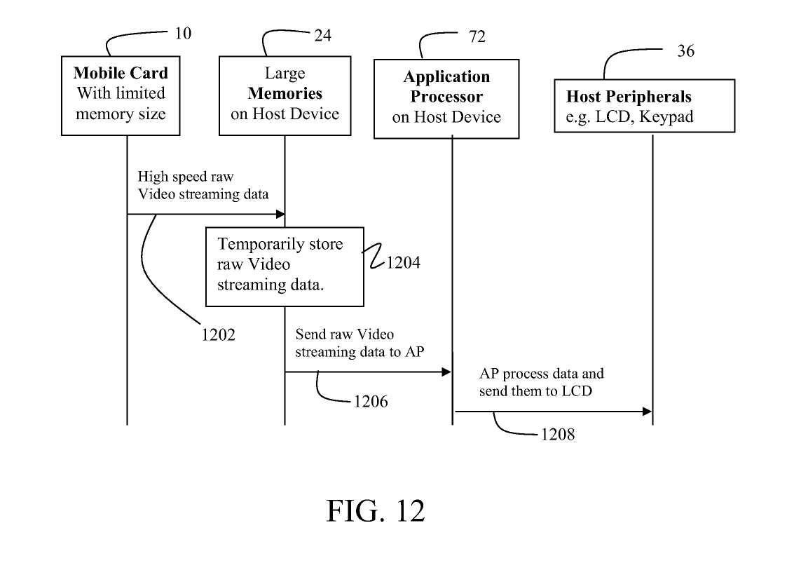

In an alternative embodiment shown in FIG. 11, for a PDA or smart-phone with a primary application processor 72 would also share its memory 24 with mobile card. The memories on handset 70 act as bridge between mobile card and handset application processor which in turn controls the LCD 36a, Keypad 36b, Camera Module 36c, speaker and microphone system 36e and SD/MMC 36d during operation of the handset. Exemplary functioning of this type of embodiment is shown in FIG. 12 for the MID host memory acting as a temporary storage for video stream data between mobile card and the primary applications processor. Certain applications such as mobile TV need the applications processor to process (e.g. MPEG4 decoding) raw data from mobile card quickly. If the applications processor does not have sufficient processing power for handling raw data in real time, the raw data needs to be stored first then processed. The embodiment shown allows memories on the mobile card to remain small by not requiring storage of such large volume of data. Memory on the MID host is typically large to accommodate other MID applications and can handle this type of storage requirement. As shown in FIG. 12, data such as high speed video is received by mobile card 10 and transmitted 1202 to memories 24 on the MID where they are cached or temporarily stored 1204. Applications processor 72 in the MID then receives the raw streaming data 1206 for processing. The processed data is then sent 1208 to the appropriate peripheral 36 on the MID such as the display LCD.

For the embodiments disclosed herein, the memories on the handset contain the software components to support host personalization or customization. Peripheral drivers for devices such as LCD, camera, etc. stored on the handset memory relieve the memory requirement on the mobile card itself to hold a variety of drivers. Host capability description information in the handset memory such as LCD configuration (screen size, resolution, color depth, etc), camera configuration, speaker configuration allows the mobile card to interpret what kind of host it is dealing with. Similarly, Man Machine Interface (MMI) configuration information for description of the menu tree structure, position, size, and text of each screen requires substantially less memory than an entire MMI application code. The mobile card downloads the MMI description from the MID memory to interpret proper display characteristics. Once a host device developer finishes the MMI customization, Software Development Kit (SDK) creates the MMI configuration information automatically for storage in the host memory.

The present invention as disclosed in the embodiments herein introduces flexibility on mobile card software customization and optimizes mobile card cost structure. The mobile card is a wireless miniaturized module with open interface that can be sold to end customers directly and is self-installable. The mobile card can also serve as a basic standardized building block to all host devices such as PDA, Smart Phone, multi-mode handset, Personal Computer, vending machine, etc. Memories, such as NAND flash, residing on host device but designated to work with a mobile card carry different application software or even operating system for different markets.

When the mobile card is plugged into a host that carries the memories with preloaded program or database, mobile card boots from these memories and download these preloaded programs into mobile card. In the exemplary embodiment herein for a mobile card based handset, memories on mobile card only carry basic protocol stack needed for wireless modem operation. The memories on the host carry all programs, such as MMI and language database, that are needed for complete handset operation. This software partition allows handset or mobile host device developer to develop application platform or software independently from mobile card development. Hence this architecture ensures easy software customization for a mobile card based host.

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. A dual memory architecture for software partition on mobile terminals comprising:
a mobile information device (MID) handset having
a first memory;
a plurality of host peripherals; and
a card interface;
a miniaturized form factor card (mobile card) received in the card interface and having a second memory including default host peripheral drivers, the interface providing operable connection from the MID memory to the mobile card, the mobile card further incorporating wireless communications components.

2. A memory architecture as defined in claim 1 wherein the first memory includes device specific host peripheral drivers, said specific host peripheral drivers uploaded to the mobile card second memory upon insertion of the mobile card in the card interface.

3. A memory architecture as defined in claim 1 wherein the card interface incorporates an open hardware interface and an open software interface.

4. A memory architecture as defined in claim 3 wherein the open hardware interface is an 8-bit NAND flash bus.

5. A memory architecture as defined in claim 3 wherein the open software interface is a standard API.

6. A method for operation of a mobile information device comprising the steps of:
providing an MID having a first memory and an interface in for a miniaturized form factor card;
providing a miniaturized form factor card having a second memory with default peripheral drivers and communications components;
inserting the card into the MID;
determining if the first memory includes host specific peripheral drivers;
if host specific peripheral drivers are present, uploading said specific peripheral drivers into the second memory and operating the peripherals through the mobile card using the specific peripheral drivers;
if host specific peripheral drivers are not present, operating the peripherals through the mobile card using default peripheral drivers.

7. A method as defined in claim 6 further wherein the step of providing an MID with a first memory includes the steps of:
coding interface software for the mobile card as a portion of the software development for the MID and
downloading the interface software into the first memory

8. A method as defined in claim 6 wherein the step of providing a mobile card with a second memory includes the step of loading the second memory with generic software for basic wireless operations that are identical or irrelevant to local handset consumers.

9. A method as defined in claim 6 wherein the setp of providing an MID with a first memory includes the step of storing a Handset Language font database in the first memory.

10. A method as defined in claim 6 wherein the provided MID includes an applications processor and wherein if host specific peripheral drivers are present, the mobile card operates the peripherals through the applications processor using the first memory as a bridge.

11. A method as defined in claim 10 wherein the step of using the memory as a bridge comprises the steps of:
streaming data from the mobile card to the memory;
temporarily storing the streamed data;
sending the raw streaming data from the memory to the applications processor;
providing the processed data to the appropriate MID peripheral.

12. A method as defined in claim 11 wherein the streamed data is video and the appropriate MID peripheral is an LCD display.
